(19) United States
(12) Patent Application Publication
(10) Pub. No.: US 2018/0094573 A1
(43) Pub. Date: Apr. 5, 2018

(54) TURBOCHARGER

(71) Applicant: ElringKlinger AG, Dettingen (DE)

(72) Inventors: Werner Schoenherr, Selters (DE); Alexander Kerth, Muensingen (DE); Maximilian Hoffmann, Eurasburg (DE)

(21) Appl. No.: 15/819,389

(22) Filed: Nov. 21, 2017

Related U.S. Application Data
(63) Continuation of application No. PCT/EP2016/061563, filed on May 23, 2016.

(30) Foreign Application Priority Data
May 26, 2015 (DE) 10 2015 108 284.5

(51) Int. Cl. F02B 37/18

(52) U.S. Cl. CPC F02B 37/186; F16K 1/2007

(57) ABSTRACT

A turbocharger is disclosed, which includes a bypass valve device with a valve element having a shaft movably connected to a valve element support, a spindle rotatable in a bearing bush to one end of which an adjusting lever is attached, and an actuator to actuate the adjusting lever. A spring element is arranged in at least one of the following positions: (A) a 1^{st} position in the region of the connection between the valve element and the valve element support, in which position the valve element shaft passes through the spring element, and (B) a 2^{nd} position between an end face of the bearing bush, and a spring element abutment, fixed to the spindle, in which position the spindle passes through the spring element, wherein the spring element is designed such that the maximum force applied by the actuator for a movement of the valve element is 600 N.

### CROSS-REFERENCE TO RELATED APPLICATIONS

This application is a continuation of International Application Number PCT/EP2016/061563, filed on May 23, 2016, which claims priority from German Application Number 10 2015 108 284.5, filed on May 26, 2015, which are incorporated by reference in their entirety and for all purposes.

### BACKGROUND OF THE INVENTION

The invention relates to a turbocharger for a reciprocating-piston internal combustion engine, comprising an exhaust gas bypass path for controlling the size of the volumetric flow of engine exhaust gas acting upon a turbine of the turbocharger, the bypass path being provided with a bypass valve device for controlling the size of the volumetric flow of exhaust gas conducted through the bypass path, the bypass valve device comprising
a plate-like valve element which has a sealing surface lying in a plane and a shaft extending away from the sealing surface, and which is movable between an open position and a closed position,
a valve seat for the valve element, the valve seat surrounding an exhaust gas through-opening and cooperating with the valve element sealing surface,
a valve element support to which the valve element is connected by means of its shaft so as to be movable at least in the direction perpendicular to the valve element sealing surface,
a spindle which is held rotatably in a bearing bush, and on one end of which there is arranged in a rotationally fixed manner, on the one hand, a first region of an adjusting lever, the first region of the adjusting lever extending transversely to the spindle, and which at the other end is operatively connected to the valve element support, and in particular is connected in a rotationally fixed manner, in such a way that, by rotating the spindle, the valve element is movable between its open and closed position, and
an actuator (drive unit) operatively connected to the adjusting lever actuating element,

wherein a spring element is arranged in at least one of the following positions:

(A) a 1^{st} position in the region of the connection between the valve element and the valve element support, wherein a play in the longitudinal direction of the valve element shaft between the valve element and its support is at least almost eliminated by the spring element through which the valve element shaft, defining a first axis, passes, and

(B) a 2^{nd} position between an end face of the bearing bush, facing towards the adjusting lever, and a spring element abutment, which is fixed to the spindle, wherein a play in the spindle longitudinal direction between the spindle and the bearing bush is at least almost eliminated by the spring element through which the spindle, defining a second axis, passes.

In particular, the invention relates to a turbocharger having the above-mentioned features, which turbocharger comprises an adjusting lever actuating element, which is connected to a second region of the adjusting lever so as to be pivotable at least about a pivot axis parallel to the axis of the spindle, wherein a spring element, alternatively or additionally to the 1^{st} position and/or the 2^{nd} position, is arranged in a 3^{rd} position in the region of the connection between the adjusting lever and the adjusting lever actuating element, and wherein a play in the direction of this pivot axis between the adjusting lever and the adjusting lever actuating element is at least almost eliminated by the spring element through which the pivot axis, defining a third axis, passes.

A turbocharger of this type is known from DE 10 2012 101 322 A1, in particular from FIG. 3 of said document.

A turbocharger of the kind concerned by the present invention can be a single turbocharger, but also a turbocharger of a multistage charger system, i.e., a system comprising a plurality of turbochargers.

In a turbocharger of the kind mentioned in the introduction, manufacturing tolerances of the components of the bypass valve device, but, above all, the time-dependent temperature changes and different temperatures of the components occurring during operation unavoidably result in a certain play occurring or even having to be present between mutually adjacent components moved relative to one another during operation, at least in certain operating states of the turbocharger. This is true in particular for the region of the connection between the valve element support and the valve element, which must be placed in an exact manner against the valve seat as it moves into its closed position; in the known turbocharger, however, the region between the adjusting lever and the end face of the bearing bush facing towards the adjusting lever is also at least not always play-free (especially because the spindle protruding into the exhaust gas region during operation of the turbocharger reaches relatively high temperatures), and it is not possible to rule out a play even for the articulated connection between the adjusting lever and the adjusting lever actuating element, wherein it should be noted in this regard that, in the known turobocharger, the adjusting lever is connected to the spindle fixedly and thus heat-conductively.

The actuator (drive unit) operatively connected to the adjusting lever actuating element, in known turbochargers, is a wastegate actuator (pressure can) or is an electromechanical drive, wherein the latter has the advantage that each intermediate position between the open and closed position of the valve element can be selectively set relatively precisely. It has now been found that, particularly when the valve element is a wastegate flap, a play in the connection between the valve element and the valve element support, in certain intermediate positions of the valve element, results in the flow of exhaust gas causing the valve element to perform oscillatory-like movements, which lead to rattling or clattering noises when the turbocharger is in operation at certain engine speeds, which noises are disadvantageous not only because of the noise, but also because of signs of wear caused by the clattering. However, a play between the spindle and the adjusting lever and/or in the articulated connection between the adjusting lever and the adjusting lever actuating element also leads over time during operation of the turbocharger to undesirably excessive signs of wear.

Therefore, the turbocharger described in DE 10 2012 101 322 A1 has, at each of the three positions defined in the introduction, a spring element in the form of a circular ring-shaped spring steel sheet disc, which, when installed in the 1^{st} position, is passed through by the valve element shaft and draws the valve element designed as a wastegate flap against the valve element support, when installed in the 2^{nd} position is passed through by the spindle and at least almost eliminates a play (in the direction of the spindle axis) between the bearing bush and the adjusting lever fixedly connected to the spindle and thus between the spindle and a turbine housing, in which the bearing bush is fixedly inserted, and when installed in the 3^{rd} position is passed through by the pivot axis of the connection between the adjusting lever and the adjusting lever actuating element and at least almost eliminates a play (in the direction of this pivot axis) between the adjusting lever and the adjusting lever actuating element.

In the known turbocharger the circular ring-shaped spring steel sheet disc has the form of a flat disc spring with a half bead surrounding the ring axis or spring axis, which half bead is resiliently elastic on account of the material properties of the spring steel sheet disc, so that the spring steel sheet disc has a radially inner supporting region and a radially outer supporting region, wherein the latter is offset relative to the radially inner supporting region in the direction of the spring axis.

Since each of these spring elements, i.e., each of these spring steel sheet discs, must be installed with a specific bias (in the direction of the spring axis) in order to overcome play, each of these spring elements leads to an increase of the force to be applied by the actuator for a movement of the valve element—when installed in the 2^{nd} and/or 3^{rd} position on account of the increased friction, caused by the spring bias, between the bearing bush fixed to the housing and the adjusting lever pivotable relative to the turbine housing, or between the adjusting lever and adjusting lever actuating element when installed in the 1^{st} position, because during the movement of the valve element, i.e., the wastegate flap, into its closed position, the actuator must overcome the spring force of the spring steel sheet disc in order to apply the wastegate flap against the valve seat in a reliably annularly sealing manner, i.e., in order to align it with the valve seat.

In known turbochargers a wastegate used as actuator can apply a force, depending on its size, of approximately 100 N to approximately 200 N, and by contrast the known electromechanical drives used as actuators can apply a force of at most approximately 600 N, before they are switched off for protection of the electromechanical drive by the controller thereof.

### SUMMARY OF THE INVENTION

On this basis, it is proposed in accordance with the invention, in order to increase the operational reliability of a turbocharger of the type defined in the introduction, to design the at least one spring element in respect of its spring hardness in such a way that the force to be applied by the actuator for a movement of the valve element, in particular for a movement of the valve element into its closed position, is at most 600 N and preferably ranges from approximately 50 N to approximately 600 N.

As a result of the invention, it is ensured that the actuator can always reliably move and adjust the valve element in any operating state of the turbocharger, i.e., in particular under all operating temperatures, which also means, in the case of an electromechanical drive preferably to be used as actuator, that this is not automatically switched off by its controller when the turbocharger is in operation.

The implementation according to the invention of the spring element or of the spring elements in respect of the spring hardness means that the force to be applied by the actuator does not need to exceed a value of approximately 600 N in order to move the valve element, in particular into its closed position, either with just one spring element in one of the three positions, or with use of a plurality of spring elements in a plurality of positions or all possible positions.

It is clear from the above that the spring element or the spring elements must be designed in respect of its/their spring hardness to be all the softer, the more spring elements the bypass valve device has. However, this does not mean that the spring elements must all have the same spring hardness, since a spring element in the 2^{nd} or in the 3^{rd} position causes an increase in the force to be applied by the actuator in that the actuator must overcome the friction caused by the spring element in question or the frictional torque caused by the spring element, which is usually greater in the 2^{nd} position than in the 3^{rd} position, whereas with a spring element installed in the 1^{st} position the actuator must provide a gastight arrangement of the valve element against the valve seat, for which purpose the actuator must at least partially overcome the spring force of the spring element as appropriate—if the spring hardness or spring force of a spring element installed in the 1^{st} position is too great for the maximum force applied by the actuator, the valve element might not be aligned with the valve seat, but instead relative to the valve element support.

Since, as has been discussed above, the turbocharger has play in the 1^{st} and/or 2^{nd} and/or 3^{rd} position in the absence of a spring element and a play there can lead to undesirable noises and/or signs of wear during operation of the turbocharger, the at least one spring element is designed in particular in such a way that in the installed state it is acted on in the direction of the first and/or second and/or third axis by a force of at least 1 N—even small forces of this type lead to a relevant reduction of the play and thus of the above-discussed disadvantages.

It is also considered to be within the scope of the present invention if an actuator operatively connected to the adjusting lever directly actuates the adjusting lever without intermediate arrangement of an adjusting lever actuating element (in this case the 3^{rd} installation position is omitted) or actuates the adjusting lever with intermediate arrangement of another adjusting mechanism, which is not connected to the adjusting lever pivotably, but in another way.

In a turbocharger according to the invention, a spring element, alternatively or additionally to a spring element in the 2^{nd} position, can also be arranged in a 4^{th} position between an end face of the bearing bush, facing towards the valve element support, and a counter bearing, fixed to the spindle, wherein a play in the spindle longitudinal direction between the spindle and the bearing bush is at least almost eliminated by the spring element through which the spindle passes.

In economically producible embodiments of the invention, the spring element, as is known per se, comprises at least one spring in the form of a substantially ring-shaped spring steel sheet disc of such a configuration that the spring steel sheet disc is resiliently elastically flattenable in the direction of its ring axis, which can be provided in the simplest way or, in respect of the support of the spring, in the most advantageous way with a spring steel sheet disc that has a radially inner and at least one radially outer supporting region, which supporting regions are each axially effective, wherein the at least one radially outer supporting region is offset in the direction of the ring axis relative to the radially inner supporting region. Here, it is recommended to use a spring steel sheet disc with a bead that is resiliently elastic in the direction of its ring axis and that surrounds the ring axis at least in portions and is configured and dimensioned taking into account the spring properties of the spring steel sheet disc in such a way that the aforementioned play, in the relevant installation position of the spring element, is at least almost eliminated during operation of the turbocharger as well. Embodiments of the spring steel sheet disc provided with the bead in which the bead is configured as a half bead are particularly preferred, since a half bead already leads to a spring steel sheet disc having radially inner and radially outer supporting regions offset axially relative to one another. Instead of the above-described, particularly preferred embodiments of the spring with radially inner and radially outer supporting regions, embodiments can also be provided in which the annular spring is formed only by a spring steel sheet in the form of a hollow truncated cone, the axial end of which having the smaller or larger diameter can be adjoined by a radially inner or, respectively, a radially outer axially effective supporting region, wherein the first alternative is preferred.

As can be seen clearly in particular from FIG. 3 of DE 10 2012 101 322 A1, in a turbocharger of the type defined in the introduction, the installation space available for a spring element is extremely limited in all installation positions, more specifically both in the axial and radial direction (based on the axis of the ring-shaped conical spring steel sheet disc forming the spring element); here, it must be kept in mind, in respect of the restriction of the installation space in the radial direction, that the spring steel sheet disc forming the spring element does not protrude, at least not significantly, in the radial direction with respect to the spring axis, beyond at least one of the two components between which the spring steel sheet disc is installed and which each form a counter bearing for the spring steel sheet disc, because otherwise one of the two counter bearings would not be effective for the radially outer supporting region of the spring steel sheet disc. With otherwise identical dimensions and material properties, the spring hardness of a conical spring steel sheet disc can be reduced both by enlarging the outer diameter and by enlarging the height of the spring steel sheet disc as measured in the direction of the spring axis; as is clear, however, from the above explanations with regard to the installation space, in the known turbocharger a reduction of the spring hardness is compensated for by an enlargement of the spring diameter of the conical spring steel sheet disc forming the spring element.

As a first measure for attaining a softer spring steel sheet disc, which, with identical outer diameter and identical axial height, has a lower spring hardness than a strictly circular ring-shaped spring steel sheet disc, as disclosed by DE 10 2012 101 322 A1, it is proposed to configure a spring steel sheet disc so that it has (seen in the direction of its ring axis) radially outer, with respect to the ring axis, approximately radially oriented supporting protrusions, which in particular have the form of radially oriented sheet tongues, which are preferably inclined relative to the ring axis. In contrast to a known conical spring steel sheet disc, which is supported over its entire outer peripheral region on an adjacent abutment, the proposed spring steel sheet disc is supported only by its supporting protrusions on the abutment, and these supporting protrusions spaced from one another in the peripheral direction of the spring steel sheet disc are more resiliently deformable than the uninterrupted outer peripheral region of the known, conical spring steel sheet disc of identical (maximum) outer diameter. A spring steel sheet disc configured in accordance with the above-mentioned measure, in spite of its low spring hardness, thus does not require a larger installation space (in the axial and/or radial direction) than the known conical spring steel sheet disc.

The same is true for a spring element configured in accordance with a second measure, which spring element comprises at least one substantially ring-shaped spring, seen in the direction of the spring axis, formed from an elongate spring steel material, which in a side view of the spring, i.e., seen perpendicularly to the spring axis, has an undulating course with a plurality of wave crests and wave troughs, wherein the spring steel material preferably forms a closed ring. A spring steel sheet strip is preferably used as spring steel material (instead of a spring steel wire, for example).

The same lastly also applies for a spring element configured in accordance with a third and a fourth measure.

The spring element formed in accordance with the third measure comprises at least one spring formed from an elongate spring steel material, which, seen in a plan view in the direction of the spring axis, forms a spiral surrounding the spring axis, with at least one turn, wherein the spiral, in a side view of the spring, i.e., seen perpendicularly to the spring axis, forms a coil that extends over at least approximately 360°.

The spring element formed in accordance with the fourth measure has at least one substantially ring-shaped spring, seen in a plan view in the direction of the spring axis, formed from an elongate spring steel material, which, in a side view of the spring, i.e., seen perpendicularly to the spring axis, forms a coil that extends over at least approximately 360°.

Also for the spring element formed in accordance with the third or the fourth measure, a spring steel sheet strip is preferably used as spring steel material.

The spring of the spring element formed in accordance with the third or the fourth measure is preferably a punched part, so that the spring can be punched out easily and economically from a spring steel sheet and can then be drawn out in the direction of the spring axis into a coil (with plastic deformation of the sheet, so that the spring forms the desired coil without being stressed).

So that, in a spring element comprising at least one spring, the outer diameter of the spring or the radial spacing of the outer regions of the spring that have the greatest radial spacing from the spring axis is not limited by the dimensions of at least one of the two components between which the spring element is installed and which form a counter bearing for said spring element, and so that consequently a spring of lower spring hardness can be used, an embodiment in which the spring element has at least one supporting plate running transversely to the spring axis, at least for outer edge regions of the at least one spring that have the greatest radial spacing from the spring axis, is recommended for a turbocharger according to the invention with a first and a second counter bearing with contact regions for the spring element installed between these counter bearings, wherein, seen in the direction of the spring axis, the spring and the supporting plate protrude beyond at least one counter bearing, more specifically in particular in the radial direction with respect to the spring axis. Here, it is advantageous if the supporting plate is stiffer than a spring steel sheet disc forming the at least one spring.

In an embodiment of this type, the spring element with the supporting plate can also be supported on a counter bearing or a component beyond which the spring lying against the supporting plate protrudes, seen in the direction of the spring axis. A spring of the spring element can then be supported on the other counter bearing or component or a further supporting plate by a radially inner, axially effective supporting region, so that the outer dimensions (seen in the direction of the axis of the spring element or the spring) of the other counter bearing are irrelevant for the dimensioning of the outer diameter of the spring.

The outer dimensions of both counter bearings or components (seen in the direction of the spring element axis) are not significant for the dimensioning of the outer diameter of the spring, if the spring is arranged between two supporting plates, one of which lies against one counter bearing and the other of which lies against the other counter bearing, and this is also true for embodiments with two supporting plates, between which a plurality of springs, in particular a plurality of identical springs, are arranged, which abut against one another by radially inner, axially effective supporting regions of the springs. The same applies, however, for the case that the spring element has two identical springs with a common spring axis, between which a supporting plate is arranged, wherein the two springs abut against the supporting plate by radially outer, axially effective supporting regions and one spring is supported against one counter bearing and the other spring is supported against the other counter bearing, more specifically in each case by a radially inner, axially effective supporting region.

In preferred embodiments of the spring element comprising one or more springs and one or more supporting plates, at least one spring outer edge region is connected to the supporting plate adjacent to the spring, for example by welding or by folding the spring outer edge region over the outer edge of the supporting plate.

In a turbocharger according to the invention a spring element according to the invention, additionally or alternatively to its arrangement in the above-defined 2^{nd} position, can be arranged in the bypass valve device in a 4^{th} position, specifically in a position between an end face of the bearing bush facing towards the valve element support and a spring element counter bearing fixed to the spindle, wherein, due to the spring element through which the spindle passes, a play in the spindle longitudinal direction between the spindle and the bearing bush is at least almost eliminated. The spring element counter bearing fixed to the spindle is in particular a shoulder (step) protruding radially with respect to the spindle axis or a corresponding annular collar of the spindle or an abutment element attached to the spindle periphery, such as preferably a snap ring engaging in a peripheral groove of the spindle.

On the basis of the accompanying drawings, the known turbocharger disclosed in DE 10 2012 101 322 A1 and preferred embodiments of the turbocharger according to the invention will be explained in greater detail hereinafter, wherein further features and advantages of the turbocharger according to the invention will become clear from this explanation.

### BRIEF DESCRIPTION OF THE DRAWINGS

FIG. 1 is an isometric illustration of a cut-open part of a turbine housing of the known turbocharger with a valve element configured as a wastegate flap including a valve element support;

FIG. 2 is a partly broken-open side view of a group of an assembly of the known turbocharger, wherein this group of components comprises the valve element, the valve element support, a spindle held rotatably in a bearing bush and provided with the valve element support, an adjusting lever attached to the spindle, and an adjusting lever actuating element articulatedly connected to the adjusting lever;

FIG. 2A is a view of the spindle, the valve element support, and the valve element, seen in the direction of the arrow A from FIG. 2;

FIG. 3 is the valve element provided with a shaft in a side view, and, in a sectional illustration, part of a wall of the turbine housing with a valve seat for the valve element;

FIGS. 4A, 4B and 4C are an embodiment of a spring element of the known turbocharger, more specifically a plan view and a side view and part of a section through this spring element, respectively;

FIG. 5 is a sectional illustration of part of a bypass valve device of a turbocharger according to the invention, more specifically with a first embodiment of a spring element according to the invention;

FIG. 6 is an illustration, corresponding to FIG. 5, with a second embodiment of a spring element according to the invention;

FIGS. 7 to 12 are illustrations, corresponding to FIG. 5, with a third to eighth embodiment of a spring element according to the invention provided with at least one deformation limiter;

FIG. 13 is a further sectional illustration of part of a bypass valve device of a turbocharger according to the invention, more specifically with a ninth embodiment of a spring element according to the invention;

FIG. 14 is an illustration, corresponding to FIG. 13, with a tenth embodiment of a spring element according to the invention;

FIG. 15 is a plan view of a spring of an eleventh embodiment of a spring element according to the invention;

FIGS. 15A and 15B are sections along the line A-A in FIG. 15 through a twelfth and a thirteenth embodiment of a spring element according to the invention provided with a spring according to FIG. 15;

FIG. 16 is a plan view of a spring of a fourteenth embodiment of a spring element according to the invention provided with a supporting plate;

FIG. 16A is a section along the line A-A in FIG. 16;

FIG. 17 is a plan view of the supporting plate of the fourteenth embodiment of the spring element according to the invention illustrated in FIGS. 16 and 16A;

FIG. 18 is a side view of a spring of a fifteenth embodiment of a spring element according to the invention;

FIG. 19 is a plan view of the spring shown in FIG. 18;

FIG. 20 is a plan view of a spring of a sixteenth embodiment of a spring element according to the invention;

FIG. 21 is a side view of the spring shown in FIG. 20;

FIGS. 22 and 23 are illustrations, corresponding to FIGS. 20 and 21, of a spring of a seventeenth embodiment of a spring element according to the invention; and

FIG. 24 is the region, denoted in FIG. 2 by the arrow D, of a modification of the assembly illustrated in FIG. 2 in an axial partial section.

### DETAILED DESCRIPTION OF THE INVENTION

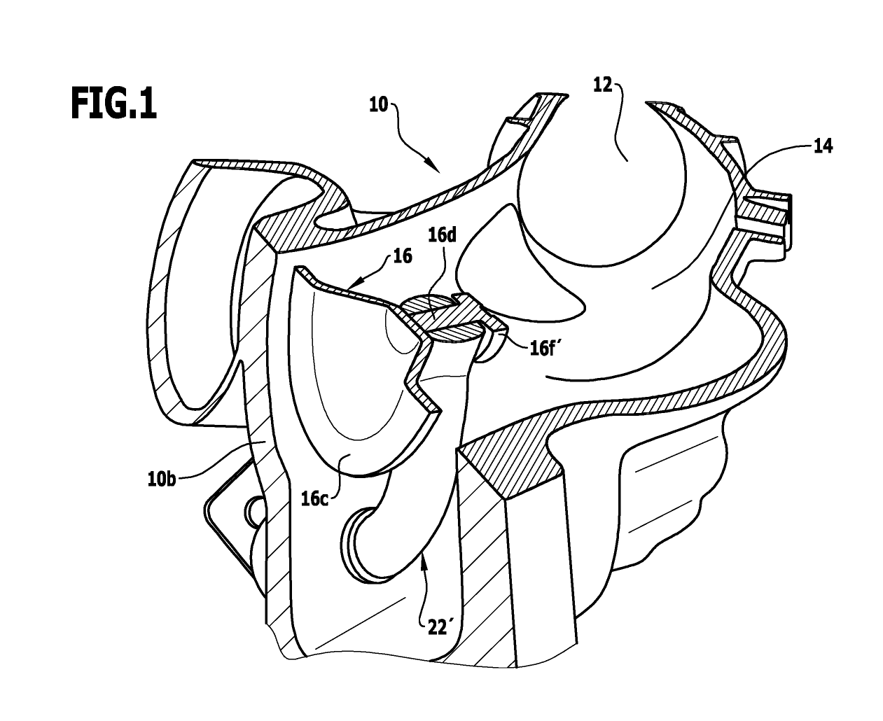

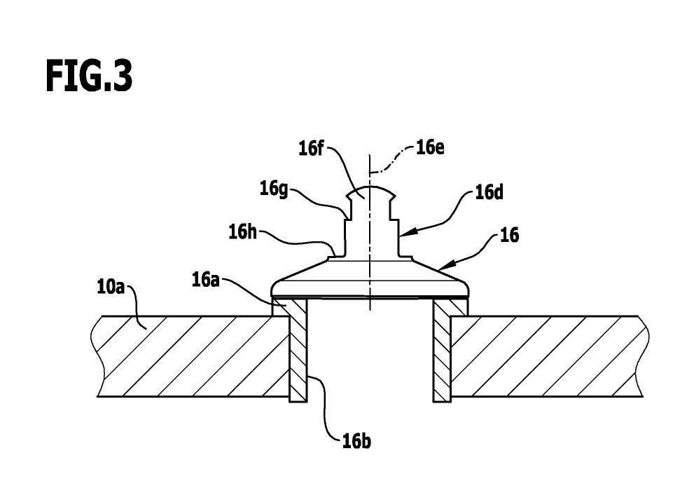

FIG. 1 shows a part of a turbine housing 10 into which the exhaust gas flow serving to drive an exhaust gas turbocharger turbine, not shown, enters through an exhaust gas inlet opening 12. The exhaust gas inlet opening 12 connects with an exhaust gas inflow path 14 formed in the turbine housing 10, which exhaust gas inflow path 14 leads to the turbine, and a valve element 16, in this embodiment configured as a wastegate flap, is arranged in the exhaust gas inflow path 14. This valve element 16 of plate-like configuration, shown only partly in FIG. 1, can be moved in a manner described below in the exhaust gas inflow path 14 relative to the turbine housing 10, to enable an exhaust gas through-opening, not shown in FIG. 1, which is formed in the wall of the turbine housing 10 to the left of the valve element 16 to be completely closed and in as gastight a manner as possible—for this purpose a wall 10a of the turbine housing 10 shown in FIG. 3 is provided with a valve seat 16a which surrounds the exhaust gas through-opening 16b, also shown in FIG. 3. As will be clear from the following, in the embodiment shown, the valve element 16 is moved in such a way that it is able not only to completely close, but also to open to a greater or lesser extent or completely the exhaust gas through-opening 16b. By means of the valve element 16, a bypass path for the exhaust gas flow, which is formed by a channel, not shown, formed in the turbine housing 10, can thus be closed or partly or completely opened in order to conduct the exhaust gas flow entering the turbine housing 10 completely, partly or not at all via the exhaust gas turbocharger turbine by the exhaust gas flow being optionally conducted partly or completely out of the exhaust gas inflow path 14 by way of the bypass path.

From FIGS. 1 and 3 it can be seen that the plate-like valve element 16 has a sealing surface 16c, in this case of circular ring-shaped configuration, which lies in a plane and cooperates with a corresponding sealing surface of the valve seat 16a. Formed on the plate-like valve element 16 is a shaft 16d, the axis of which was designated 16e in FIG. 3, and the free, upper end of which, in accordance with FIG. 3, is provided with a thickened head 16f. Between this head and the plate-like valve element 16, the shaft 16d has an, in accordance with FIG. 3, upper annular shoulder 16g, and an, in accordance with FIG. 3, lower annular shoulder 16h is provided at the transition from the shaft to the valve element 16.

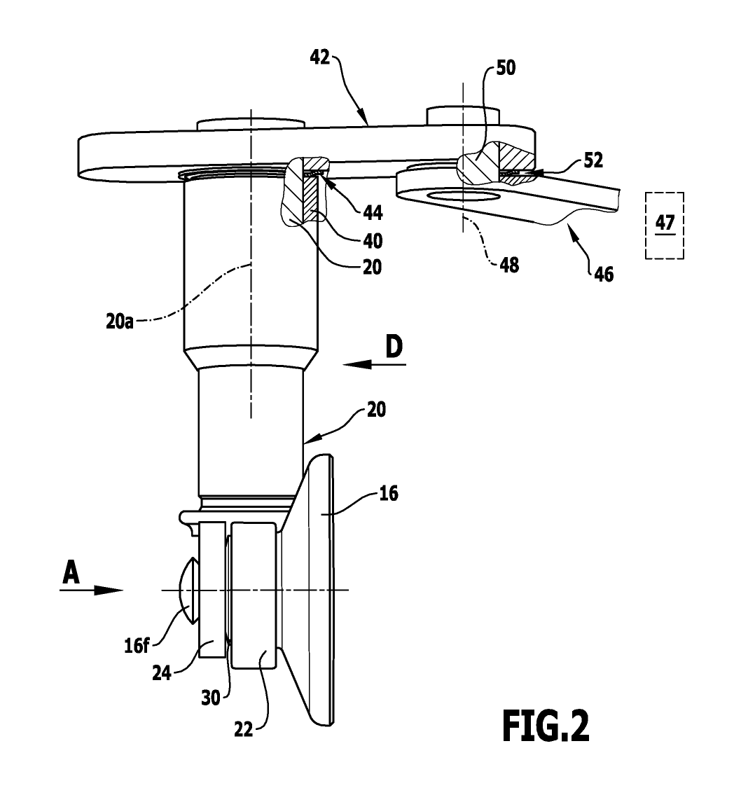

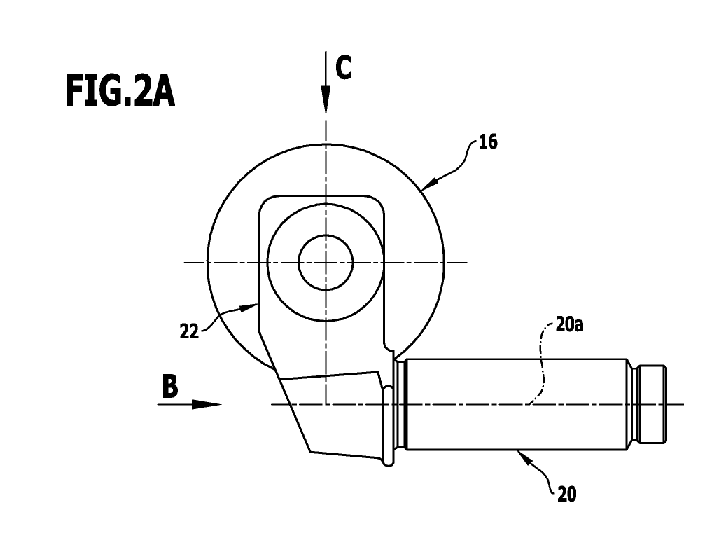

An assembly comprising the valve element, the parts carrying the valve element, and the parts moving the valve element between an open position and a closed position will be described below with reference to FIGS. 2 and 2A.

Belonging to this assembly is a shaft-like spindle 20, on which is formed a valve element support 22, which extends in the manner of an arm transversely away from the spindle 20 comprising an axis 20a, and over the major part of its length has a substantially rectangular cross section and, therefore, two flat sides. In the proximity of its free end, the valve element support 22 has an, in particular, circular, hole, through which the shaft 16d passes with little play, so that the annular shoulder 16h provided at the transition from this shaft to the valve element 16 can be supported on one flat side of the valve element support 22.

Arranged between the head 16f of the shaft 16d and the valve element support 22 is a washer 24, which has two end faces, preferably overall flat and parallel to each other, one of which is supported on the annular shoulder 16g of the shaft 16d. The spacing of the two annular shoulders 16g and 16h from each other, the thickness of the region of the valve element support 22 provided with the hole and the thickness of the washer 24 are matched so as to obtain between the washer 24 positioned by the head 16f against the annular shoulder 16g and the valve element support 22 abutting against the annular shoulder 16h an annular gap in which is arranged a first ring-shaped spring 30, through which the shaft 16d passes.

For assembly, the shaft 16d provided on the valve element 16 is first passed through the hole 22c of the valve element support 22, whereupon the spring 30 and the likewise ring-shaped washer 24 are pushed onto the shaft 16d, and the washer is positioned against the annular shoulder 16g. The free end of the shaft 16d, which at first does not yet have the head 16f, is then deformed by a kind of riveting procedure so as to produce the thickened head 16f, during formation of which the washer 24 is pressed against the annular shoulder 16g, and by means of which the valve element 16 is secured on the valve element support 22, and the spring 30 and the washer 24 are held on the shaft 16d.

As is clear from FIG. 2, the spring 30 abuts with its two sides against flat surfaces extending perpendicularly to the axis 16e, which are formed by a side of the valve element support 22 and an end face of the washer 24. The design and function of the spring 30 will be described below.

As shown in FIG. 2, the spindle 20 is held by a bearing bush 40 and is mounted therein so as to be rotatable about the spindle axis 20. The bearing bush 40 is secured in a wall 10b, discernible from FIG. 1, of the turbine housing 10, however, it is also possible for the spindle 20 to be arranged directly in a correspondingly shaped opening of the wall 10b and to be mounted rotatably about the spindle axis 20a.

Regarding FIG. 1, it must also be pointed out that it shows an embodiment of the valve element support, which is modified in comparison with FIG. 2A and was designated 22′ in FIG. 1. Furthermore, FIG. 1 shows an alternative configuration of the free end of the shaft 16d of the valve element 16, for which reason this free shaft end forming an abutment was designated 16f′ in FIG. 1. Finally, mention is made of the fact that FIG. 1 shows an arrangement of the valve element 16 on the valve element support 22′, which has been modified compared to FIG. 2.

The, in accordance with FIG. 2, upper end of the spindle 20 passes through a hole, not discernible in FIG. 2, of an adjusting lever 42 and is connected to the latter at least in a rotationally fixed manner, but preferably also so as not to be displaceable in the direction of the spindle axis 20a and in a gastight manner. The person skilled in the art is familiar with the means required for this, which, therefore, need not be explained. Arranged between the bearing bush 40 (but optionally the wall 10b of the turbine housing 10) and the adjusting lever 42 is a ring-shaped further spring 44, through the opening of which the spindle 20 passes, and which abuts, on the one hand, against the adjusting lever 42 and, on the other hand, against the, in accordance with FIG. 2, upper end face of the bearing bush 40, (but optionally against the wall 10b). Those regions of the adjusting lever 42 and of the end face of the bearing bush 40 (or the wall 10b) against which the spring element 44 lies are preferably so configured that they are flat and extend perpendicularly to the spindle axis 20a. The design and function of the spring 44 will also be described below.

An adjusting lever actuating element 46 engages the adjusting lever 42, which is rotatable together with the spindle 20 about the spindle axis 20a, and in the embodiment shown in FIG. 2 the adjusting lever actuating element 46 is of arm-like or lever-like configuration, but it could also have a different form, as it need only fulfil the function of being able to pivot the adjusting lever 42 about the spindle axis 20. The adjusting lever actuating element 46 is articulated on the adjusting lever 42 in such a way that it can be pivoted relative to the adjusting lever 42 at least about a pivot axis 48 extending parallel to the axis 20a of the spindle 20. A ball-and-socket joint can, for example, be used for the articulated connection between the adjusting lever 42 and the adjusting lever actuating element 46. In the embodiment shown in FIG. 2, this articulated connection is formed by a joint pin 50 the axis of which coincides with the pivot axis 48, and which passes through a hole in the adjusting lever 42 and at least engages in a hole in the adjusting lever actuating element 46. The joint pin 50 can, for example, be attached to the adjusting lever actuating element 46, in particular, by welding, whereas the joint pin 50 can be rotated relative to the adjusting lever 42 about the pivot axis 48. In this case, in order to secure the adjusting lever actuating element 46 to the adjusting lever 42, there can be attached to the joint pin 50 a securing element, which abuts against the, in accordance with FIG. 2, upper side of the adjusting lever 42 and is held on the joint pin 50 so as not to be displaceable in the axial direction.

Also arranged between the adjusting lever 42 and the adjusting lever actuating element 46 is a ring-shaped spring 52, through the opening of which the joint pin 50 passes, and which abuts at one side against the adjusting lever 42 and at the other side against the adjusting lever actuating element 46. Alternatively, however, a ring-shaped washer, through which the joint pin 50 passes, could also be provided between the spring 52 and the adjusting lever 42 and/or the adjusting lever actuating element 46. In each case, it is preferable to so configure those surfaces against which the spring 52 abuts that these surfaces are flat and extend perpendicularly to the pivot axis 48.

The adjusting lever actuating element 46 is actuated by an actuator 47, merely indicated in the drawing, directly or also with interpositioning of one or more mechanical connection elements, such that, by means of the adjusting lever actuating element 46, the adjusting lever 42 is pivoted about the spindle axis 20a and the spindle 20 is thus rotated about its axis 20a in order to thus move the valve element 16 between its open and closed position. Since actuators of this kind are known to the person skilled in the art, there is no need for a more detailed illustration or description of such an actuator.

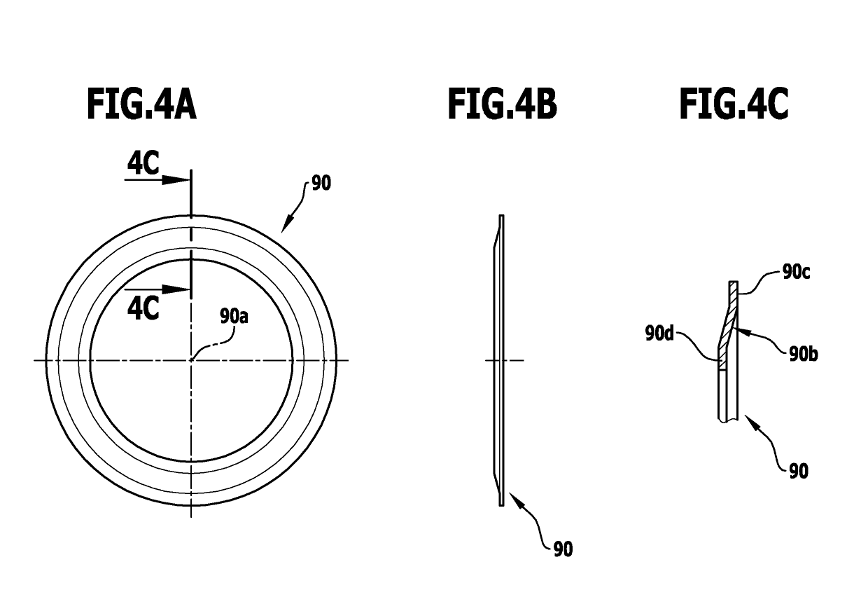

With reference to FIGS. 4A, 4B and 4C, a spring will now be described, which can be used as a spring 30, 44 and/or 52. In this connection, it is pointed out that the spring 44 should in any case effect a gas sealing, in order that exhaust gases which may penetrate a gap between the periphery of the spindle 20 and the component on which the spindle is mounted, i.e., in particular, the bearing bush 40, are unable to escape to the outside in the region of the, in accordance with FIG. 2, upper end of the bearing bush 40 or the housing wall 10b. On the other hand, the problem of gas sealing might not arise at the installation position of the spring 30 or at the installation position of the spring 52, and, therefore, these two springs need only be so configured with respect to their design, their material properties and their dimensions that a play in the direction of the axis 16e of the shaft 16d of the valve element 16 or a play in the direction of the pivot axis 48 is at least almost eliminated by these springs, more specifically, also under the operating temperatures of the turbocharger, which, above all, is of particular importance for the spring 30.

In view of the above-described installation positions of the springs in accordance with the invention, the reference numerals 30, 44 and 52 used so far have not been used for the springs in FIGS. 4A to 4C, but instead another reference numeral.

FIGS. 4A to 4C show a spring 90, which also consists only of a single circular ring-shaped spring steel sheet disc and defines a spring axis by means of a central axis 90a. The section illustrated in FIG. 4C along the line 4C-4C in FIG. 4A shows that the spring steel sheet disc has a half bead 90b surrounding the spring axis 90a, which means that the spring formed by the spring steel sheet disc has a radially outer, axially effective supporting region 90c and a radially inner and also axially effective supporting region 90d, which are offset relative to one another in the direction of the spring axis 90a and are preferably flat and run perpendicularly to the spring axis 90a.

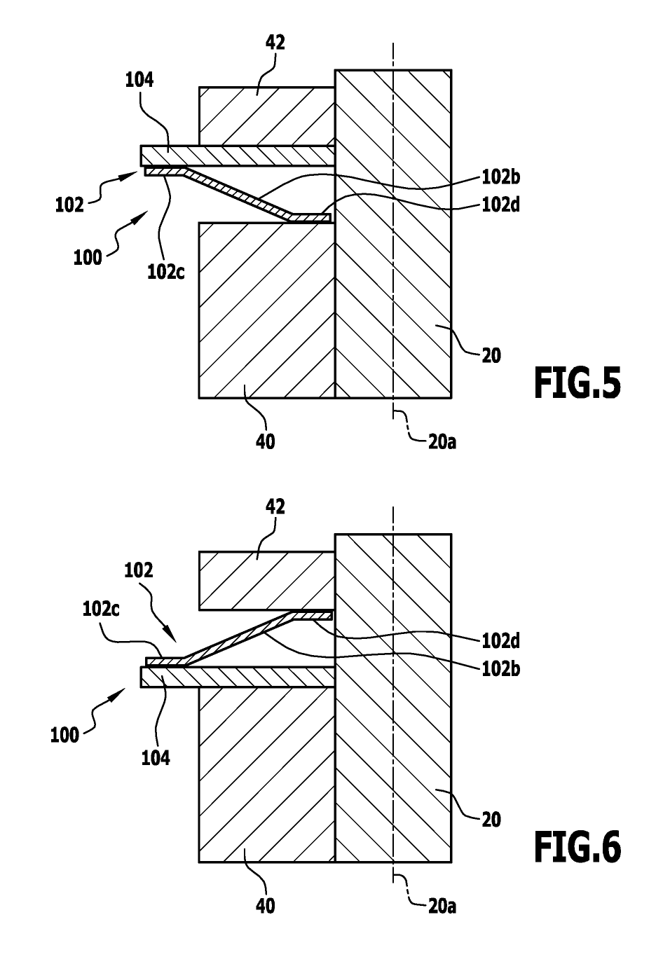

Particularly advantageous embodiments of a spring element according to the invention which can be installed in any of the above-defined four positions, i.e. in particular can be provided at the point of one or more of the springs 30, 44 and 54, will be explained in greater detail on the basis of FIGS. 5 to 23.

For the sake of simplicity, the installation position in which the spring 44 is disposed in FIG. 2 has been selected for the illustrations in FIGS. 5 to 14.

FIG. 5 shows schematically the bearing bush 40, which comprises, in this spindle 20 mounted rotatably about its axis 20a, the adjusting lever 42 attached to the spindle and a spring element according to the invention denoted as a whole by 100, which spring element comprises a spring 102 and a supporting plate 104. The spring 102 can be a spring steel sheet disc similarly to the spring steel sheet disc illustrated in FIGS. 4A to 4C and described above, in other words the spring 102, seen in the direction of the spindle axis 20a, is ring-shaped, in particular circular ring-shaped, and has a radially inner, axially effective supporting region 102d, a radially outer and axially effective supporting region 102c, a half bead 102b between the two supporting regions, and a central opening (not referenced), through which the spindle 20 passes with little play; seen in the direction of the spindle axis 20a, the inner supporting region 102d, the half bead 102b, and the outer supporting region 102c surround the spindle 20 in a ring-shaped manner in each case, in particular in a circular ring-shaped manner. The spindle axis 20a thus also forms the spring axis of the spring 102.

In the installed state of the assembly, the spring 102 is biased in the direction of the spring axis and the half bead 102b is resiliently slightly flattened in the direction of the spring axis compared to the unloaded spring, that is to say the axial offset of the two supporting regions 102c and 102d is slightly smaller when the spring is installed than when the spring is unloaded, that is to say not yet assembled.

In contrast to the spring 44 shown in FIG. 2, however, the spring element 100 protrudes beyond its two counter bearings in the radial direction (seen in the direction of the axis 20a and in relation thereto)—in the illustrated embodiment the two counter bearings are formed by the bearing bush 40 and the adjusting lever 42; at the position of the adjusting lever, however, an annular shoulder formed by a step of the spindle 20, or another abutment element fixedly attached to the spindle 20 in the direction of its axis could be used, for example an annular collar of the spindle 20 or a snap ring, which engages in an annular groove provided on the outer periphery of the spindle 20.

So that all radially outer regions of the spring 102 are also supported, although they protrude at least in part in the radial direction beyond the, in accordance with FIG. 5, upper counter bearing, that is to say in particular beyond the adjusting lever 42, the spring element 100 comprises the supporting plate 104, through the central opening of which the spindle 20 passes with little play and which preferably has the form of a circular disc (seen in the direction of the spindle axis 20a), but is at least configured so that the radially outer supporting region 102c can be supported all over on the supporting plate 104, which is much stiffer than the spring 102, and in particular in those regions of the supporting plate that protrude outwardly in the radial direction beyond the, in accordance with FIG. 5, upper counter bearing, i.e. the adjusting lever 42 in the illustrated embodiment.

Due to its larger radial dimensions compared to the spring 44, the spring 102 has a lower spring hardness than the spring 44 (with otherwise identical dimensions and with identical material properties), so that the adjusting lever 42 or the, in accordance with FIG. 5, upper counter bearing can be rotated relative to the bearing bush 40, that is to say relative to the other counter bearing, with lower force or with a lower torque than is the case with a harder spring—under the assumption that the spring 44 does not rotate relative to the bearing bush 40, the adjusting lever 42 must be rotated at least relative to one of the elements of the spring element 100, that is to say at least relative to the supporting plate 104 or relative to the spring 102, when the spindle 20 is rotated relative to the bearing bush 40.

The second embodiment of a spring element according to the invention shown in FIG. 6 differs from the embodiment illustrated in FIG. 5 merely in the orientation and arrangement of the spring or the supporting plate, for which reason the same reference signs as in FIG. 5 have been used in FIG. 6.

In the embodiment according to FIG. 6, the supporting plate 104 abuts against the bearing bush 40, and the inner supporting region 102d of the spring 102 abuts against the, in accordance with FIG. 6, upper counter bearing, that is to say against the adjusting lever 42, in particular and whereas in the embodiment according to FIG. 5 the spring element 100 protrudes beyond at least the upper counter bearing, that is to say the adjusting lever 42, in the radial direction, in the embodiment according to FIG. 6, the spring element 100 protrudes at least beyond the lower counter bearing, that is to say the bearing bush 40, in the radial direction.

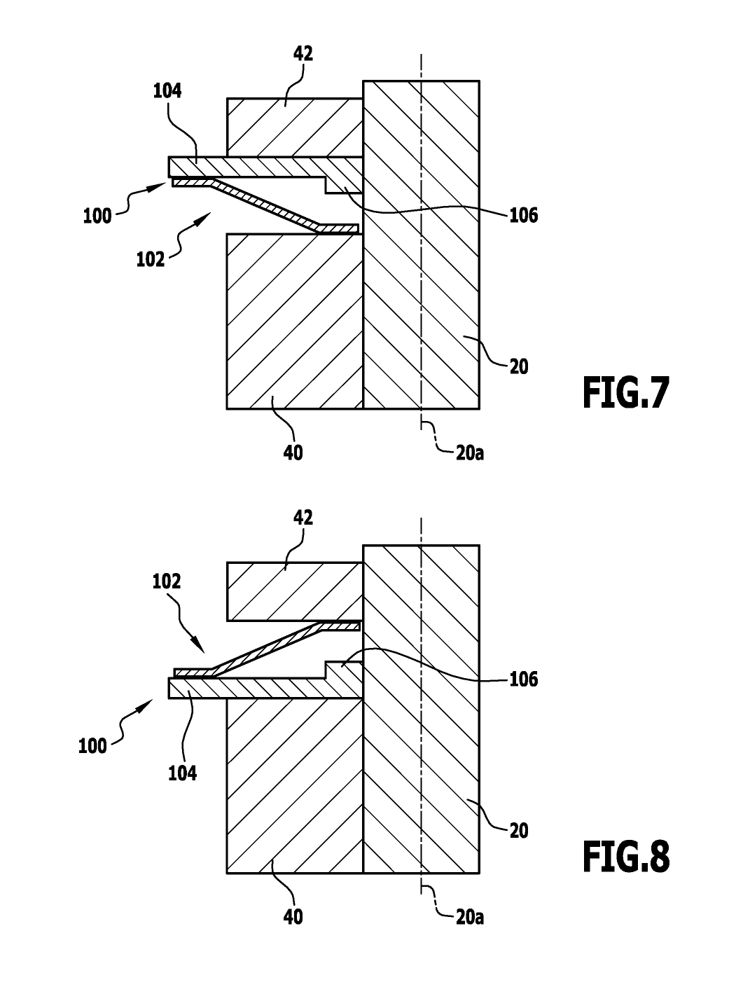

The embodiments according to FIGS. 7 and 8 differ from the embodiments according to FIGS. 5 and 6 merely in that the supporting plate is provided with a deformation limiter (usually referred to as a stopper) for the bead, that is to say in particular for a half bead of the spring, for which reason the same reference signs as in FIGS. 5 and 6 have been used in FIGS. 7 and 8, apart from the referencing of the stopper.

In the embodiments according to FIGS. 7 and 8, the supporting plate 104 is provided with a stopper 106, which prevents an excessive flattening of the half bead 102b and in particular directly borders the spindle 20. The stopper 106 preferably surrounds the spindle 20 in the form of a closed circular ring-shaped protrusion, however the stopper 106 could also be formed by a plurality of axial protrusions, which are spaced from one another in the peripheral direction of the spindle 20. In particularly advantageous embodiments, the stopper 106 is integrally moulded on the supporting plate 104. The stopper 106 preferably extends in the radial direction over the entire radial width of the inner supporting region 102d of the spring 102.

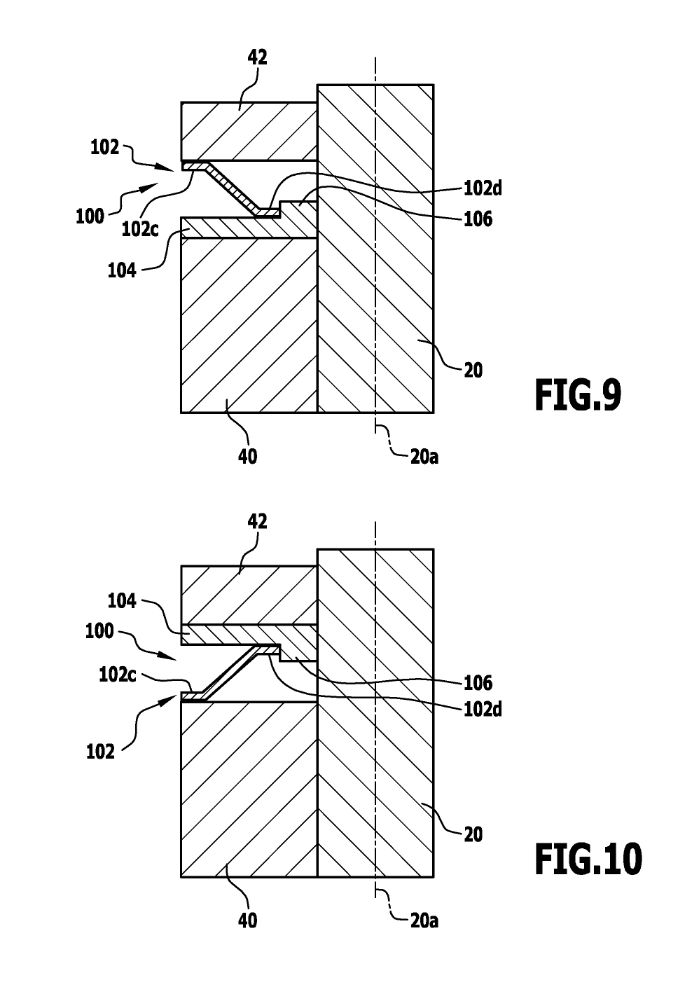

The fifth and sixth embodiments of a spring element according to the invention illustrated in FIGS. 9 and 10 differ from the third and fourth embodiments illustrated in FIGS. 7 and 8 merely in that the spring 102 does not cover the stopper 106 (seen in the direction of the spring axis), for which reason the same reference signs as in FIGS. 5 to 8 have been used in FIGS. 9 and 10. In addition, FIGS. 9 and 10 are intended to clarify that the spring element 100 according to the invention does not have to protrude in the radial direction beyond either of the two counter bearings, that is to say in the present case neither the bearing bush 14 nor the adjusting lever 42, when the spring has a lower spring hardness on account of other measures, which will be explained hereinafter.

In the embodiments shown in FIGS. 9 and 10, the spring 102 extends radially inwardly only as far as the outer periphery of the stopper 106 and abuts with its radially inner supporting region 102d against the supporting plate 104, whereas it abuts with its radially outer supporting region 102c against one of the two counter bearings, in particular against the adjusting lever 42 or the bearing bush 40.

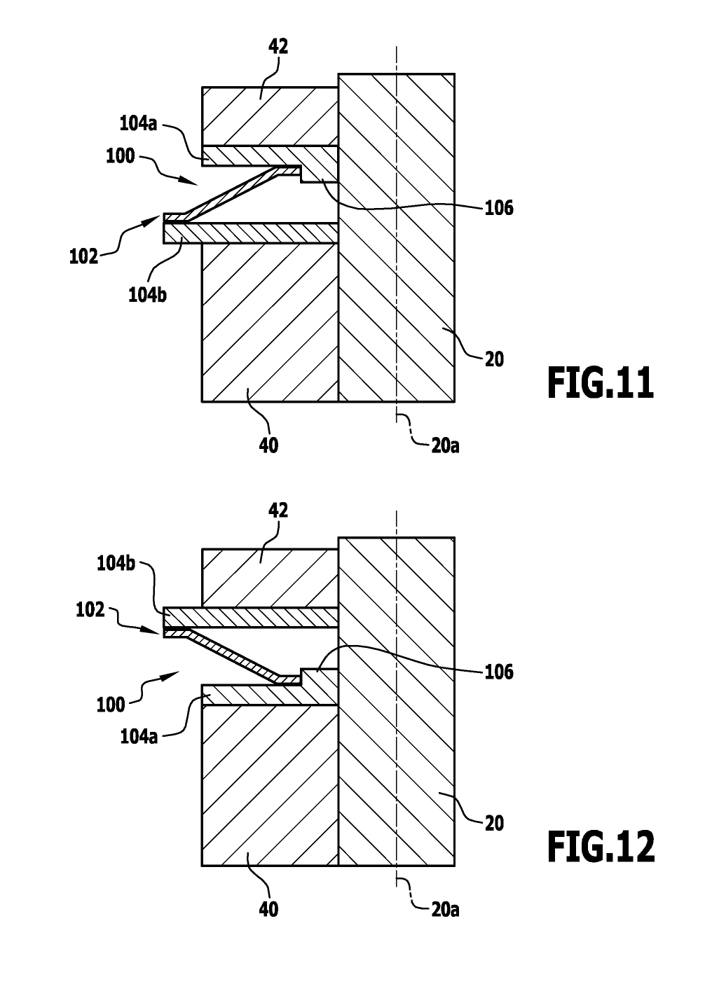

The seventh and eighth embodiments of a spring element according to the invention illustrated in FIGS. 11 and 12 are characterized by two supporting plates 104a and 104b, one of which supports a radially inner supporting region and the other of which supports a radially outer supporting region of the spring 102. In addition, one of the two supporting plates is provided with a stopper 106 for the half bead 102b.

In the embodiments illustrated in FIGS. 11 and 12, the spring element 100 again protrudes beyond one of the two counter bearings, specifically the bearing bush 40 or the adjusting lever 42, and under consideration of FIGS. 11 and 12 it can be seen that only one of the two supporting plates, in the illustrated case the supporting plate 104b, must protrude beyond this counter bearing in the radial direction in order to be able to support the radially outer supporting region of the spring 102 all over.

In contrast to that illustrated in FIGS. 11 and 12, the two supporting plates 104a and 104b, however, can also be configured so that each of these supporting plates protrudes beyond the counter bearing adjacent thereto in the radial direction.

The embodiments illustrated in FIGS. 11 and 12, however, can also be modified so that the stopper 106, instead of being arranged on the supporting plate 104a, is arranged on the supporting plate 104b, more specifically opposite a radially inner supporting region (see 102d in FIGS. 5 and 6) of the spring 102.

Lastly, it is also possible, although not preferred, to dispense with a stopper for the spring, that is to say in the illustrated case for the spring 102.

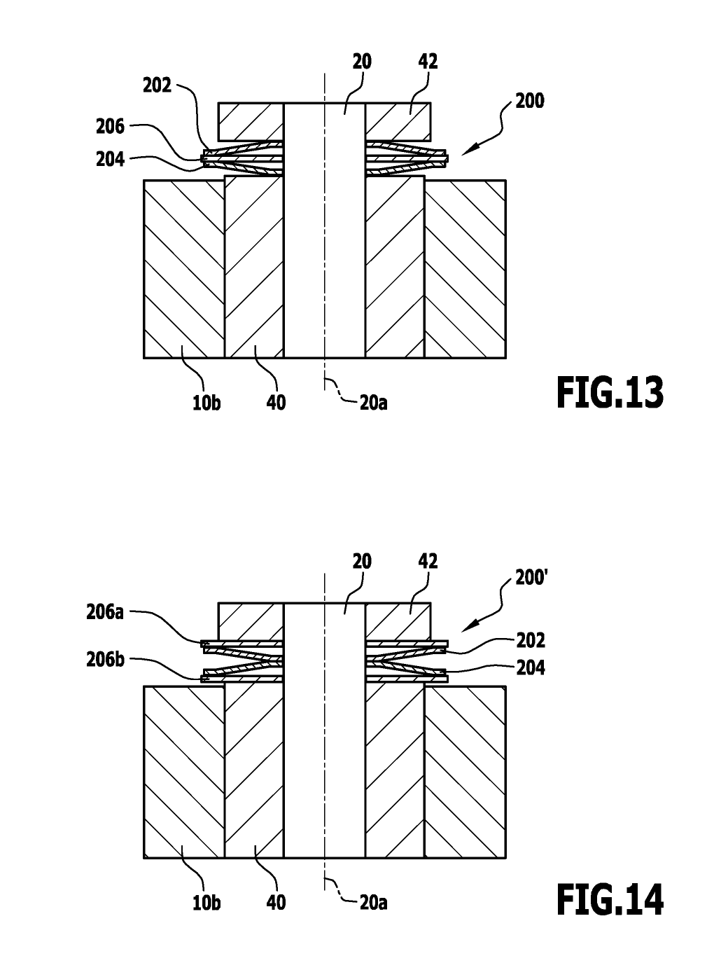

A ninth and tenth embodiment of a spring element according to the invention, more specifically a spring element 200 and, respectively, a spring element 200′, are illustrated, respectively, in FIGS. 13 and 14. Here, FIGS. 13 and 14 show the bearing bush 40 installed in a wall 10b of the turbine housing 10 for supporting the spindle 20 and the adjusting lever 42 attached to the spindle, between which adjusting lever and the bearing bush 40 there is installed the spring element 200 or 200′.

In the embodiment according to FIG. 13, the spring element 200 has a supporting plate 206 arranged between two springs 202 and 204, which supporting plate protrudes beyond the two counter bearings, in the illustrated case the bearing bush 40 and the adjusting lever 42, in the radial direction, as do the two springs 202 and 204, which again are spring steel sheet discs each provided with a half bead.

In this embodiment, the two springs 202, 204 abut with their radially outer supporting regions against the supporting plate 206, whilst the radially inner supporting regions of the springs are each supported against one of the two counter bearings respectively.

The two springs 202, 204 are preferably configured and arranged in a mirror image with respect to the supporting plate 206.

In the embodiment according to FIG. 14, the spring element 200′ has two supporting plates 206a and 206b, between which there are arranged a plurality of springs 202 and 204 (in the present case two springs) in the form of ring-shaped, in particular circular ring-shaped, spring steel sheet discs, each of which has a circular ring-shaped half bead between a radially inner and a radially outer supporting region. The springs 202 and 204 are in particular configured and arranged in a mirror image with respect to a centre plane of the spring element 200′ running perpendicularly to the spindle axis, and abut with their radially inner supporting regions against one another, and are each supported with their radially outer supporting regions on one of the supporting plates 206a or 206b respectively.

In the embodiment illustrated in FIG. 14 as well, the spring element 200′ protrudes with its springs and its supporting plates beyond the two counter bearings in the radial direction relative to the spring axis or the spindle axis 20a.

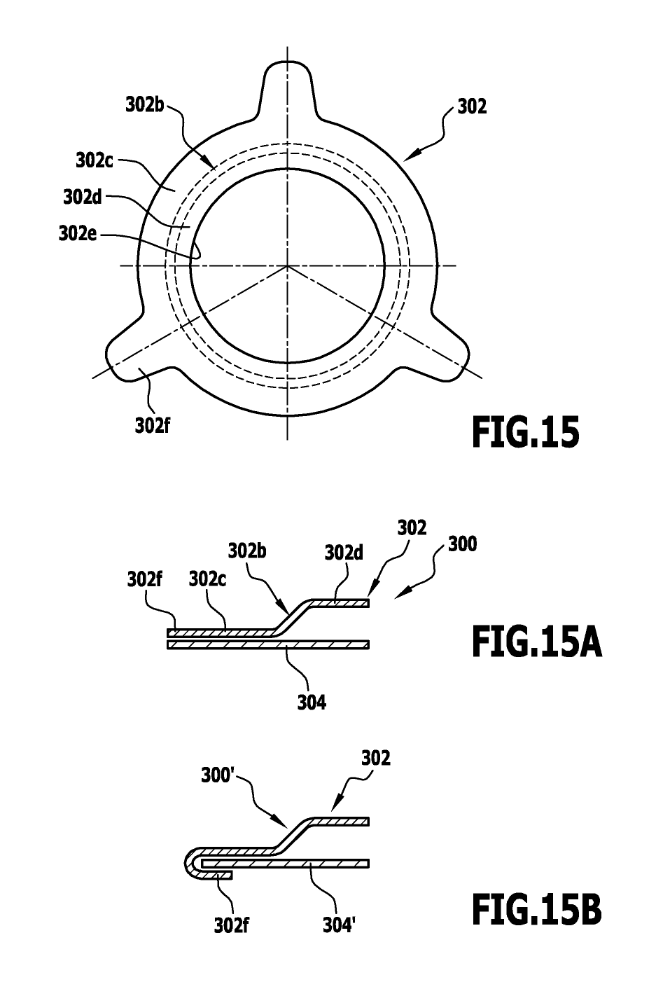

Hereinafter, with reference to FIGS. 15, 15A and 15B, it will be explained how, in preferred embodiments of a spring element according to the invention, the spring of said spring element having the form of a spring steel sheet disc can be advantageously connected to a supporting plate.

FIG. 15 shows a plan view of a spring 302 in the form of a substantially circular ring-shaped spring steel sheet disc with a central opening 302e and a circular ring-shaped half bead 302b between a radially outer supporting region 302c and a radially inner supporting region 302d. At its outer periphery, the spring 302 is provided with a plurality of nose-like or lobed sheet tabs 302f, which are spaced from one another in the peripheral direction. The spring 302 can therefore be produced from a spring steel sheet as a single punched part, into which the half bead 302b is impressed.

FIGS. 15A and 15B show two embodiments of a spring element according to the invention containing the spring 302, specifically a spring element 300 and, respectively, a spring element 300′, more specifically in each case in a partial section in accordance with the line A-A in FIG. 15.

The spring element 300 has a flat supporting plate 304, the outer diameter of which corresponds at least approximately to the outer diameter of the spring 302, inclusive of the tabs 302f thereof, and in the case of the spring element 300 these tabs lie flat on the supporting plate 304 and are fixedly connected to the supporting plate, in particular by spot welding.

By contrast, the spring element 300′ has a flat supporting plate 304′ with an outer diameter corresponding at least approximately to the outer diameter of the radially outer supporting region 302c of the spring 302, so that the tabs 302f thereof can be folded over the supporting plate 304′ in order to connect the spring 302 to the supporting plate 304′ (see FIG. 15B).

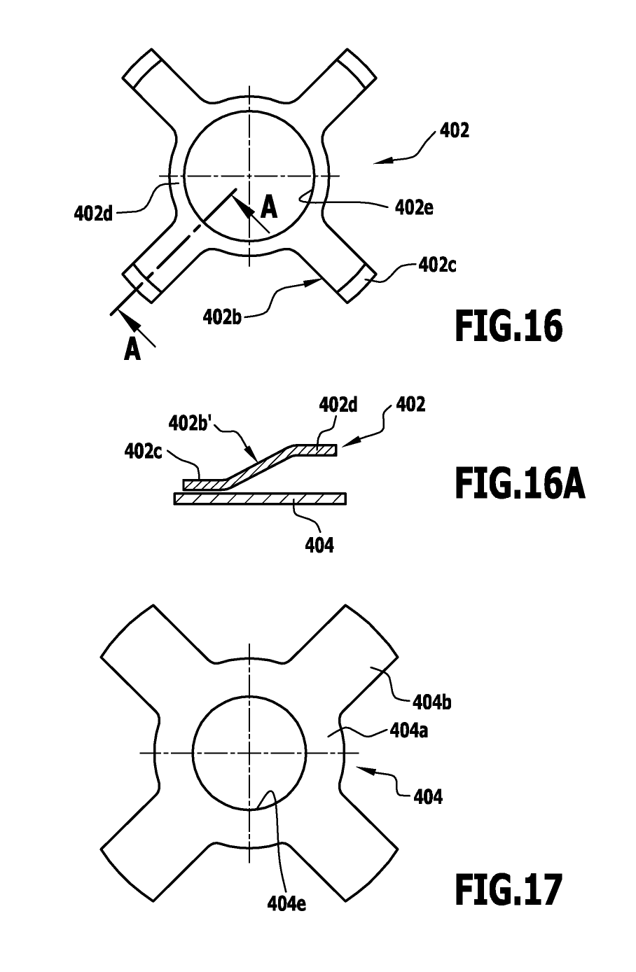

With reference to FIGS. 16, 16A and 17, a fourteenth embodiment of a spring element according to the invention is explained, and it is made clear that, in accordance with the invention, a lower spring hardness can also be attained by a measure other than by an enlargement of the outer diameter of a spring bearing a likeness to a spring steel sheet disc.

FIG. 16 shows a plan view of a spring 402 of a spring element 400 illustrated in FIG. 16A in a partial section; the spring 402 was punched out from a spring steel sheet and has a central opening 402e, which is surrounded by a circular ring-shaped radially inner supporting region 402d, at the outer periphery of which there are provided a plurality of spring arms 402b spaced from one another in the peripheral direction. As can be seen in FIG. 16A, which illustrates a section through the spring element 400 along the line A-A in FIG. 16, the spring arms 402b each form a radially outer supporting region 402c and each have a half bead 402b′, on account of which the radially outer supporting regions 402c and the radially inner supporting region 402d are offset relative to one another in the direction of the axis of the spring 402 visible in FIG. 16.

The spring element 400 has a flat supporting plate 404, which can be seen in FIG. 16A and is illustrated in FIG. 17 in a plan view, the form of which supporting plate 402 corresponds substantially to the form of the spring 402 in a plan view in the direction of the axis of the spring element 400 coinciding with the axis of the spring 402. The supporting plate 404 has a central opening 404e, which is surrounded by an, in particular, circular ring-shaped ring region 404a, and a plurality of arms 404b, which protrude in the radial direction beyond the outer periphery of the ring region 404a, and are spaced from one another in the peripheral direction of this ring region. When the spring element 400 is assembled, the spring arms 402b of the spring 402 lie above the arms 404b of the supporting plate 404 (seen in the direction of the axis of the spring element 400) and the radially outer supporting regions 402c of the spring arms 402b are supported on the arms 404b of the supporting plate 404.

The supporting plate 404 is also preferably a punched part punched out from a steel sheet, the stiffness of said supporting plate being significantly greater, at least in the region of the arms 404b, than the stiffness of the spring arms 402b of the spring 402.

The radially outer supporting regions 402c can be fixedly connected to the arms 404b of the supporting plate 404, in particular by spot welding.

The spring element 400 according to the invention has the following advantages:

Since the spring 402 is not a circular ring-shaped spring steel sheet disc, but instead (seen in the direction of the spring axis) has a plurality of spring arms 402b that are radially oriented or that each form an acute angle with the radial direction and that are arranged at considerable spacings from one another in the peripheral direction of the spring 402, the spring 402 punched out in particular from a spring steel sheet has a much lower spring hardness than a circular ring-shaped spring steel sheet disc, punched out from the same spring steel sheet, of identical outer diameter compared to the spring 402 (inclusive of the spring arms 402b thereof).

In addition, the design of the spring element 400 with its arms 402, 404b spaced from one another enables an installation of the spring element 400 at points of the bypass valve device at which at least one of the two counter bearings accommodating the spring element therebetween has one or more protrusions such that a spring element with an at least substantially circular ring-shaped spring steel sheet disc cannot be used.

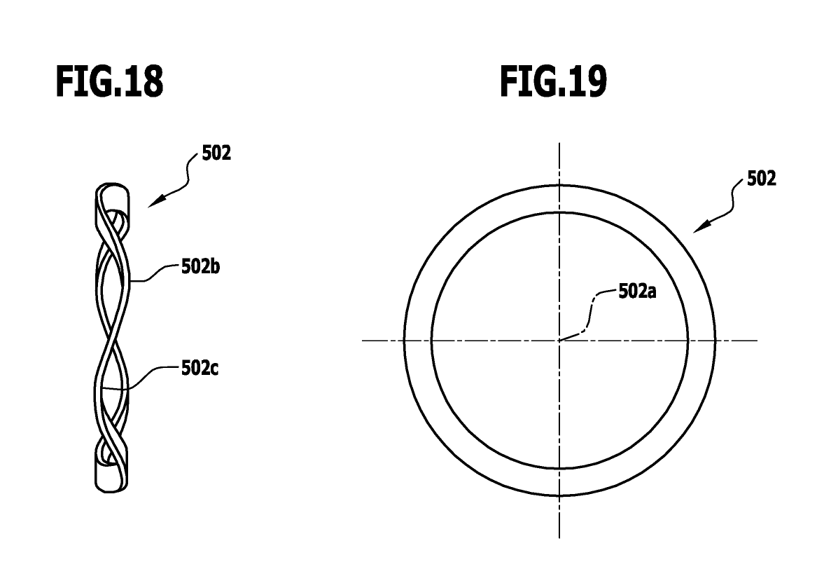

FIGS. 18 and 19, 20 and 21, and 22 and 23 illustrate, respectively, particularly preferred embodiments of springs of a fifteenth, sixteenth and seventeenth version of a spring element according to the invention, wherein all of these springs have a much lower spring hardness than an at least substantially circular ring-shaped spring steel sheet disc of identical outer diameter and formed from the same spring steel sheet as the springs shown in FIGS. 18 to 23.

The spring 502 illustrated in FIGS. 18 and 19 has, in a plan view in the direction of its spring axis 502a, the form of a closed strip and in particular of a circular ring, and has preferably been cut out, in particular punched out, from a spring steel sheet, that is to say the spring 502 is formed at least substantially (apart from any coatings possibly provided) from an elongate spring steel material, that is to say in particular from a spring steel sheet strip, which preferably forms a closed ring, but which in principle could also be separated at a particular point, thus forming a narrow gap.

As can be seen in FIG. 18, the elongate spring steel material, that is to say in particular the spring steel sheet strip, has an undulating form with a plurality of wave crests 502b and wave troughs 502c following one another in alternation. The wave form, however, does not have to have a sinusoidal course (as illustrated in FIG. 18), and instead could be formed by successive beads, which in particular are trapezoidal in a side view.

The spring hardness of the spring 502 (in the direction of the spring axis 502a) can be set advantageously by the choice of the width of the spring steel sheet strip, but additionally or alternatively also by the height or depth, measured in the direction of the spring axis 502a, and/or the length, measured in the peripheral direction, of the wave crests and wave troughs (apart from the spring properties of the spring steel material).

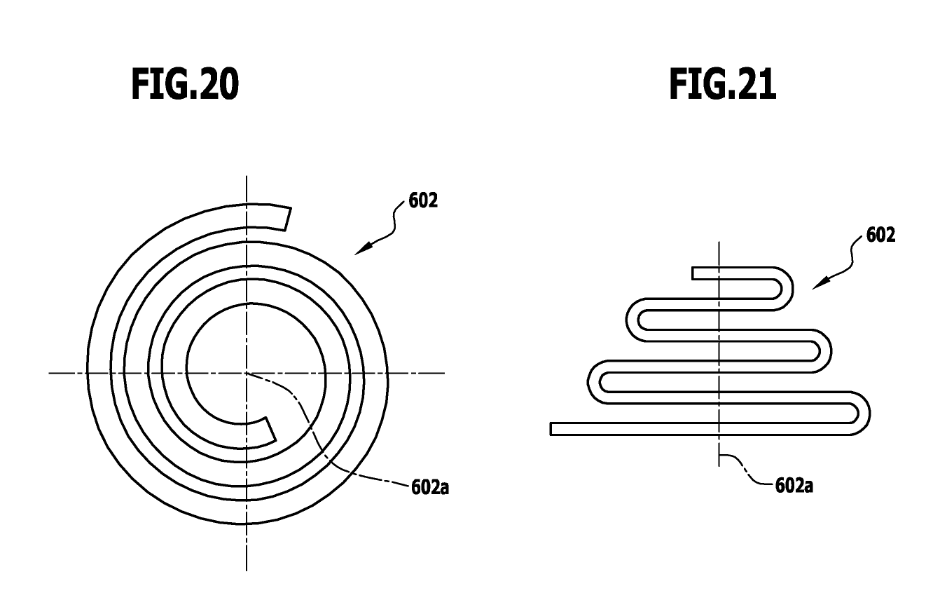

The spring 602 illustrated in FIGS. 20 and 21 has also been produced from an elongate spring steel material, in particular from a spring steel sheet strip, however the ends of this material/strip are not connected to one another, and said material or strip, in a plan view of the spring in the direction of the spring axis 602a, forms a spiral surrounding said spring axis. In a side view of the spring 602, the elongate spring steel material or the spring steel sheet strip, however, forms a coil (see FIG. 21), so that the spring 602, with one of its axial ends, specifically with its, in accordance with FIG. 21, upper axial end, forms a radially inner supporting region and with its other axial end region, specifically with its, in accordance with FIG. 21, lower axial end region, forms a radially outer supporting region.

The number of turns of the spiral and/or the pitch of the coil and/or the width of the spring steel sheet strip can be selected so that the spring 602 has the desired spring hardness in the direction of its spring axis 602a.

In contrast to that illustrated in FIG. 20, the turns of the spiral can also be arranged adjacently without a significant radial gap.

The spring 602 can be easily cut out, in particular punched out, from a spring steel sheet and can then be brought into the desired coil form by drawing out the turns of the spiral (in the direction of the spring axis 602a), wherein the elongate spring steel material naturally must also be plastically deformed so that the spring 602 exerts a spring force in the direction of the spring axis 602a in the installed, that is to say slightly flattened, state.

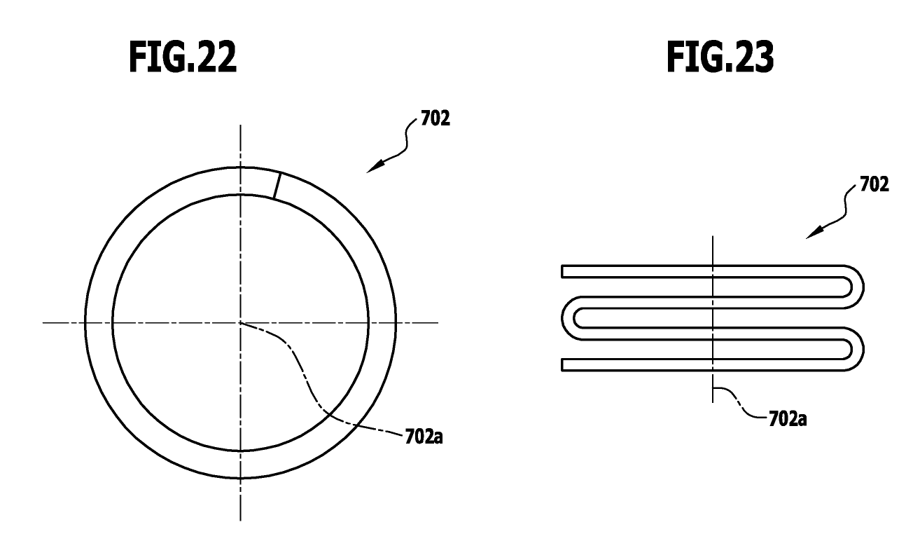

The spring 702 illustrated in FIGS. 22 and 23 differs from the spring 602 according to FIGS. 20 and 21 merely in that the elongate spring steel material, that is to say in particular a spring steel sheet strip, seen in a plan view in the direction of the spring axis 702a, does not have the form of a spiral, but instead has the form of a frame or in particular ring-shaped structure. Also with a spring formed in accordance with the spring 702, the designer can freely choose the number of turns and/or the pitch of the coil (see FIG. 23) and/or the width of the spring steel sheet strip, so that he can set the spring hardness of the spring (in the direction of the spring axis) as desired.

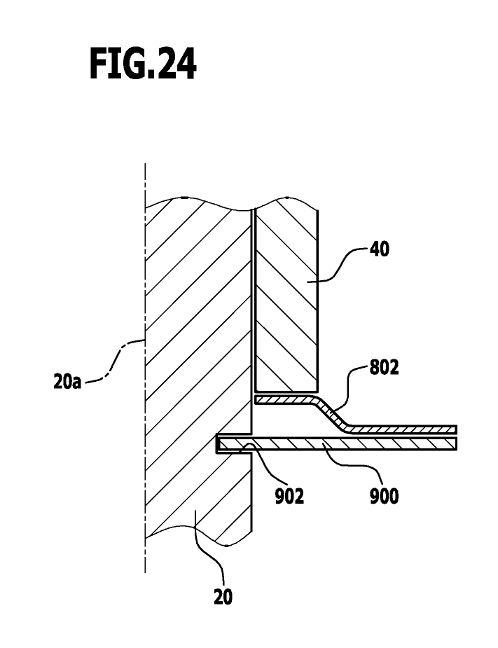

As already mentioned, FIG. 24 shows the region, denoted by the arrow D in FIG. 2, of a modification of the assembly illustrated in FIG. 2, in an axial partial section, and FIG. 24 serves for the purpose of showing that a spring element according to the invention, apart from being arranged in one or more of the above-defined 1^{st} to 3^{rd} positions, can additionally or alternatively also be arranged in accordance with the invention in a 4^{th} position.

FIG. 24 again shows the spindle 20 mounted rotatably about an axis 20a in a bearing bush 40, but additionally a spring element according to the invention, formed by a spring 802, which in particular is a circular ring-shaped spring steel sheet disc, through which the spindle 20 passes with a small radial play. The spring element or the spring 802 is installed between two counter bearings acting in the axial direction, one of which is formed by the, in accordance with FIG. 2, lower end face of the bearing bush 40, and the other of which is formed by an counter bearing 900, fixed to the spindle at least in the direction of the spindle axis 20a. The latter counter bearing could be a shoulder provided on the outer periphery of the spindle 20 or could be an outer annular collar of the spindle 20, however in the case illustrated in FIG. 24, the counter bearing 900 is to be formed by a snap ring, which is held in an annular groove 902 of the spindle 20.

Insofar as the springs of the spring elements according to the invention have ring-shaped radially inner supporting regions, spring regions which have recesses and/or which are provided with cut-outs along the edge of the central spring opening could also be formed at this point.

One or both of the counter bearings accommodating therebetween a spring element according to the invention could also have supporting regions for the spring element, which supporting regions do not form continuously flat areas around the central spring element opening, and instead for example have indentations between flat area regions.

The half bead of the above-described springs of spring elements according to the invention could also be interrupted in the peripheral direction, for example on account of openings punched out from the spring steel sheet, or because only bead segments that are spaced from one another in the peripheral direction of the spring were impressed into the spring steel sheet.

The rigidity of the half bead (in the direction of the spring axis) can be selected by a suitable cross-sectional design of the half bead, whether by the height and/or the width and/or the angle of inclination of the half bead (in the cross section through the half bead).

The following materials are recommended as spring steel materials for the springs of spring elements according to the invention:

for a spring in the region of the valve element and between bearing bush and adjusting lever, nickel-based alloys, optionally with anti-friction coatings and/or high-temperature-resistant coatings known from the prior art; for a spring in the adjusting mechanism between the actuator and the spindle, a conventional spring steel, optionally with an anti-friction coating; and for a spring in the region of the end of the bearing bush facing the valve element, nickel-based alloys or high-temperature-resistant spring steels, optionally with an anti-friction coating and/or a high-temperature-resistant coating.

The following steel alloys are very particularly preferred:
NiCo20Cr20MoTi (2.4650), alloy DIN 17744/17750 in accordance with DIN 59746/DIN EN ISO 9445
alloy 625 (2.4856), DIN EN 10095
Waspaloy (2.4654)
NiCr19Fe19Nb5Mo3 (2.4668) in accordance with DIN 59746/DIN EN ISO 9445
Ni19.5Cr10Co8.5Mo1.5Al2Ti (trade name HAYNES 282).

The first aforementioned alloy is recommended, above all, for a spring element according to the invention which is installed in the same position as the spring 30, and the last alloy is recommended especially for a spring element according to the invention which is installed in the same position as the spring 52. Alloy 625 and Waspaloy are, in turn, recommended for spring elements which are installed in the same position as the spring 30.

It is particularly recommended to configure a spring element according to the invention, depending on the installation position, so that it generates, in the installed state, the following pressing or spring forces between the spring element and the counter bearings adjacent thereto, more specifically in particular in the cold state, that is to say not when the turbocharger is in operation. For a single-layer or multilayer spring element according to the invention to be installed in the position of the spring 30 (see FIG. 2), a force range of between 150 and 300 N, in particular, between 170 and 320 N, is recommended, whereas a lower force range, namely in particular a force range of 30 to 150 N, is recommended for a spring element to be installed in the same position as the spring 44 or 52 or 802, in order to avoid higher wear due to the relative rotational movements occurring in this position. As already mentioned above, however, the spring force can also be much smaller, in particular can be only at least 1 N.

1. A turbocharger for a reciprocating-piston internal combustion engine, comprising an exhaust gas bypass path for controlling the size of the volumetric flow of engine exhaust gas acting upon a turbine of the turbocharger, the bypass path being provided with a bypass valve device for controlling the size of the volumetric flow of exhaust gas conducted through the bypass path, the bypass valve device comprising:
a plate-like valve element which has a sealing surface and a shaft extending away from the sealing surface, and which is movable between an open position and a closed position,
a valve seat for the valve element, the valve seat surrounding an exhaust gas through-opening and cooperating with the valve element sealing surface,
a valve element support to which the valve element is connected by means of its shaft so as to be movable at least in the direction perpendicular to the valve element sealing surface,
a spindle which is held rotatably in a bearing bush, on which on the one hand there is arranged in a rotationally fixed manner a first region of an adjusting lever, the first region of the adjusting lever extending transversely to the spindle, and which on the other hand is operatively connected to the valve element support, in such a way that, by rotating the spindle, the valve element is movable between its open and closed position, and
an actuator operatively connected to the adjusting lever actuating element, wherein a spring element is arranged in at least one of the following positions:
(A) a 1^{st} position in the region of the connection between the valve element and the valve element support, wherein a play in the longitudinal direction of the valve element shaft between the valve element and its support is at least almost eliminated by the spring element through which the valve element shaft, defining a first axis, passes, and
(B) a 2^{nd} position between an end face of the bearing bush, facing towards the adjusting lever, and a spring element abutment, which is fixed relative to the spindle, wherein a play in the spindle longitudinal direction between the spindle and the bearing bush is at least almost eliminated by the spring element through which the spindle, defining a second axis, passes,
and wherein the at least one spring element is designed in respect of its spring hardness in such a way that the force to be applied by the actuator for a movement of the valve element from its open position into its closed position is at most 600 N.

2. The turbocharger according to claim 1, wherein the bypass valve device further comprises an adjusting lever actuating element, which is connected to a second region of the adjusting lever so as to be pivotable at least about a pivot axis parallel to the axis of the spindle, and wherein a spring element, alternatively or additionally to the 1^{st} position and/or the 2^{nd} position, is arranged in a 3^{rd} position in the region of the connection between the adjusting lever and the adjusting lever actuating element, wherein a play in the direction of this pivot axis between the adjusting lever and the adjusting lever actuating element is at least almost eliminated by the spring element through which the pivot axis, defining a third axis, passes.

3. The turbocharger according to claim 1, wherein the spring element comprises at least one spring in the form of a substantially ring-shaped spring steel sheet disc of such a configuration that the spring steel sheet disc is flattenable resiliently elastically in the direction of its ring axis

4. The turbocharger according to claim 3, wherein the spring steel sheet disc has a radially inner, axially effective supporting region and at least one radially outer, axially effective supporting region, and the latter is offset relative to the radially inner supporting region in the direction of the ring axis.

5. The turbocharger according to claim 3, wherein the spring steel sheet disc has a bead which is resiliently elastic in the direction of the ring axis of said spring steel sheet disc and which surrounds the ring axis at least in portions, which bead is configured and dimensioned taking into account the spring properties of the spring steel sheet disc in such a way that the aforementioned play is at least almost eliminated also when the turbocharger is in operation.

6. The turbocharger according to claim 5, wherein the bead is configured as a half bead.

7. The turbocharger according to claim 3, wherein the spring steel sheet disc, seen in the direction of its ring axis, has outer supporting protrusions approximately radially oriented in respect of the ring axis.

8. The turbocharger according to claim 1, wherein the spring element comprises at least one spring, which is substantially ring-shaped as seen in a plan view in the direction of the first or second or third axis and which is formed from an elongate spring steel material, which, in a side view of the spring, has an undulating configuration with a plurality of wave crests and wave troughs.

9. The turbocharger according to claim 8, wherein the spring steel material forms a closed ring.

10. The turbocharger according to claim 8, wherein the spring steel material is a spring steel sheet strip.

11. The turbocharger according to claim 1, wherein the spring element comprises at least one spring formed from an elongate spring steel material, which, seen in a plan view in the direction of the first or second or third axis, forms a spiral surrounding the axis in question and having at least one turn, and wherein the spiral, in a side view of the spring, forms a coil which extends over at least approximately 360°.

12. The turbocharger according to claim 1, wherein the spring element comprises at least one spring, which is substantially ring-shaped as seen in a plan view in the direction of the first or second or third axis and which is formed from an elongate spring steel material, which in a side view of the spring forms a coil which extends over at least approximately 360°.

13. The turbocharger according to claim 11, wherein the spring steel material is a spring steel sheet strip.

14. The turbocharger according to claim 11, wherein the spring is a punched part.

15. The turbocharger according to claim 3, which has a first and a second counter bearing for the spring element, between which counter bearings the spring element is installed, wherein the spring element, at least for outer edge regions of the at least one spring that have the greatest radial spacing from the spring axis, has at least one supporting plate running transversely to the spring axis, and wherein, seen in the direction of the spring axis, the spring and the supporting plate protrude beyond at least one counter bearing.

16. The turbocharger according to claim 5, which has a first and a second counter bearing for the spring element, between which counter bearings the spring element is installed, wherein the spring element, at least for outer edge regions of the at least one spring that have the greatest radial spacing from the spring axis, has at least one supporting plate running transversely to the spring axis, on which supporting plate there is provided a deformation limiter for the bead.

17. The turbocharger according to claim 16, wherein, seen in the direction of the spring axis, the spring and the supporting plate protrude beyond at least one counter bearing.

18. The turbocharger according to claim 15, wherein, seen in the direction of the spring axis, the spring and the supporting plate protrude beyond both counter bearings.

19. The turbocharger according to claim 15, wherein the spring element comprises two springs of the same type with a common spring axis, which are arranged one above the other in the direction of the spring axis.

20. The turbocharger according to claim 19, wherein the two springs abut with their outer edge regions against the supporting plate arranged between the springs.

21. The turbocharger according to claim 19, wherein the two springs are arranged between two supporting plates and each spring abuts with its outer edge regions against the supporting plate adjacent thereto.

22. The turbocharger according to claim 15, wherein the outer edge regions of the spring are connected to the supporting plate adjacent thereto.
